(19) United States
(12) Patent Application Publication
(10) Pub. No.: US 2020/0071240 A1
(43) Pub. Date: Mar. 5, 2020

(54) Compost bin having compostable sheet.

(71) Applicant: Monica Radu, ARLINGTON HEIGHTS, IL (US)

(72) Inventor: Monica Radu, ARLINGTON HEIGHTS, IL (US)

(21) Appl. No.: 16/120,614

(22) Filed: Sep. 4, 2018

(51) Int. Cl. C05F 17/02; C05F 5/00

(52) U.S. Cl. CPC C05F 17/0205; C05F 17/0258; C05F 5/002

(57) ABSTRACT

A device comprising at least one sheet detachably attached to a plurality of members, the sheet defining a chamber for containing plant debris. The members support one end of the chamber in an open configuration. The device receives plant debris through the open end and contains the plant debris while the plant debris composts therein. In embodiments of this invention, the sheet is made of material composition which is compostable in a natural environment, and has a carbon: nitrogen ratio substantially consistent with the carbon: nitrogen ratio of plant debris contained therein. In embodiments of this invention, the sheet is made of material composition which is compostable in a natural environment at a rate substantially consistent with the rate of composting of plant debris contained therein.

### FIELD OF THE INVENTION

The present invention is concerned with composting devices, in particular, with a compost bin having compostable sheet.

### BACKGROUND AND PRIOR ART

Disposal of plant debris has been a growing problem for municipalities and landfill waste handlers, who are struggling to process a very large volume of plant debris and landfill waste. Many municipalities have collection and composting programs for plant yard debris, separate from collection of landfill waste, however capacity may not be adequate. The problem of large volumes of landfill waste is also exacerbated in many areas where there is no municipality program for composting kitchen scraps, therefore these are thrown in the garbage and increase the volume of landfill waste.

A solution is needed to compost plant yard debris and kitchen scraps by individuals in a natural environment (for example, in a back yard or other outdoors location under naturally occurring conditions) in order to free up collection and processing capacity of municipal and industrial composting facilities, and reduce the volume of kitchen scraps in landfills. Prior art does not provide an easy and environmentally friendly solution to this problem.

Prior art includes compost bins made of non-compostable material composition, for example plastics or other synthetic material composition. Problems with these prior art compost bins are that they exacerbate the very problem they are meant to solve, since the prior art compost bins are disposed of in the landfill or recycled, thereby adding to the volume of landfill or take up capacity in recycling facilities.

Other prior art includes compost bins made of degradable plastics which are degradable in municipal or industrial facilities, but are not degradable or extremely slowly degradable in a natural environment. Examples of degradable plastics are plastics which meet the standard by ASTM International (American Society for Testing and Materials) D6400 for ‘Plastics Designed to be Aerobically Composted in Municipal or Industrial Facilities’. However, according to a report published in 2015 by the United Nations Environment Programme, titled ‘Degradable Plastics & Marine Litter—misconceptions, concerns and impacts on marine environments’, a quotation states: “the bio-plastic PLA is a polyester, produced from lactic acid derived from agricultural crops such as maize and sugar cane, and it can be biodegraded by a variety of micro-organisms (Eubeler et al. 2010). However, despite the biological origins degradation under natural environmental conditions is very slow and it requires industrial composting for complete biodegradation (GESAMP 2015) ‘Sources, fate and effects of microplastics in the marine environment—a global assessment’. A polymer may be marketed as ‘biodegradable’ but this may only apply to a limited range of environmental conditions, which are probably not encountered in the natural environment.” The report further indicates that degradable plastics degrade extremely slowly in the oceans, which is a problem, because of spillage of landfill waste into the oceans. Therefore, problems with the prior art are that these prior art compost bins are not compostable in a natural environment, under naturally occurring conditions, but rather they need to be subject to special conditions such as highly increased temperature or humidity in an industrial or municipal composting facility. Therefore these prior art compost bins exacerbate the problem of taking up capacity in industrial or municipal composting facilities; and these prior art compost bins, if thrown in landfills or if they spill from landfills into the oceans, do not compost or compost extremely slowly.

Other prior art includes compost bins made of substantially wood material composition, including wood boards or tree branches. A problem with this prior art is that the wood material composition composts very slowly, much slower than plant debris, generally over a timeframe of many years. In addition, prior art compost bins made of wood are difficult and time consuming to install and uninstall.

Other prior art includes sacks or bags made of jute, however they do not have support to keep the bag open and the contents easily reachable. A problem with this prior art is that these are bags, but not bins; that is, the prior art has an end through which plant debris is added into the bag, but this end is not kept or supported open, so it folds or collapses and a user has to open the bag each time to add plant debris, which is time consuming and difficult. In addition, a problem with this prior art is that the lack of a supporting structure greatly inhibits the performance of the composting process, as it is difficult for a user to keep the bag open and aerate the plant debris, which is a key action necessary to provide air for the microbial process of composting of plant debris. Other prior art includes compost bins made of paper, processed from the pulp of various plants. However, the strength of paper material composition is very low or decreased in wet conditions, which are generally present in a natural environment, therefore paper falls apart very quickly in wet conditions and the contents of the compost bin spill out before the composting process of plant debris is complete.

Prior art includes a compostable bag attached to plant yard debris collecting machinery, for example a leaf vacuum or leaf blower or lawn mower. This prior art is used for collection of plant yard debris, not for composting of plant debris. The prior art bags are used solely for collection, then the collected plant yard debris need to be emptied from the prior art bags into compost bins for composting. The composting process is very different from the collecting process. In addition, this prior art has the same problem as described above for a prior art which is a bag but not a bin.

Other prior art includes compost bins for use inside the home in the kitchen, made of paper material composition. A problem with this prior art is that they are for use indoors to collect kitchen scraps and then the prior art compost bins must themselves be placed or emptied into an outdoor compost bin; they cannot be used as the outdoor compost bin themselves due to the same problems as describe above for compost bins made of paper.

Prior art includes the use of burlap to cover compost piles in order to maintain moisture. However, a cover over a compost pile is very different than a compost bin for containment of plant debris during the composting process.

The present invention solves the problems in prior art.

### BRIEF SUMMARY OF THE INVENTION

Embodiments of the present invention provide for a device, applied as a compost bin having at least one sheet, which is compostable in a natural environment, under naturally occurring conditions. The sheet forms a chamber with a first end, which is supported by a plurality of members in an open configuration, and a second bottom end.

In embodiments of the present invention, the material composition of the sheet has a carbon: nitrogen ratio substantially consistent with the carbon: nitrogen ratio of plant debris contained in the compost bin. In embodiments of the present invention, the material composition of the sheet composts at a rate substantially consistent with the rate of composting of plant debris contained in the compost bin. At the end of the composting cycle of the plant debris, the sheet is very advanced in its composting cycle. Embodiments of the present invention are an ecological solution for composting of plant debris in a natural environment, while the compost bin itself may achieve zero landfill and zero recycling impact to the environment. The sheet is ecologically beneficial to the environment, by being compostable in a natural environment, that is, it transforms into compost useful for soil conditioning or soil amendment. In embodiments of the present invention, the compost bin members may be made of wood, and may also be composted in a natural environment at the completion of many composting cycles. Embodiments of the present invention are a completely Earth-friendly compost bin, enabling users to compost plant debris, and being itself compostable in a natural environment.

In embodiments of the present invention, users easily install and uninstall the compost bin, by detachably attaching the sheet to the members. At the end of a composting cycle for the plant debris contained in the compost bin, the sheet may be detached and replaced with a newly attached sheet to form a new compost bin supported by the same members.

### BRIEF DESCRIPTION OF THE SEVERAL VIEWS OF THE DRAWINGS

FIG. 1 shows a perspective view of a compost bin.

FIG. 2 shows a side view of a compost bin.

FIG. 3 shows a view of a compost bin in a natural environment, the compost bin containing plant debris.

FIG. 4 shows an enlarged partial view of a sheet having a woven configuration.

FIG. 5 shows an enlarged partial view of a sheet detachably attached to a member.

### DETAILED DESCRIPTION OF THE INVENTION

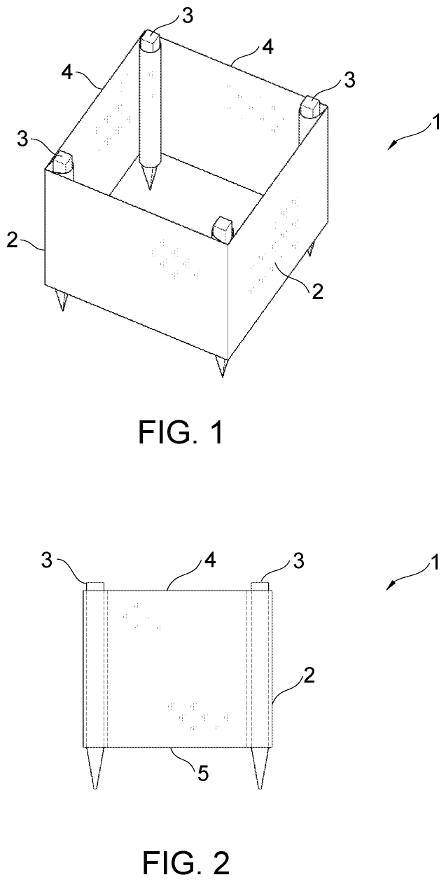

An embodiment of the current invention is a device applied as a compost bin. FIG. 1 shows a perspective view of a compost bin 1; FIG. 2 shows a side view of a compost bin 1. The compost bin 1 comprises at least one sheet 2 and a plurality of members 3. The sheet 2 forms a chamber having an open end 4 and a bottom end 5.

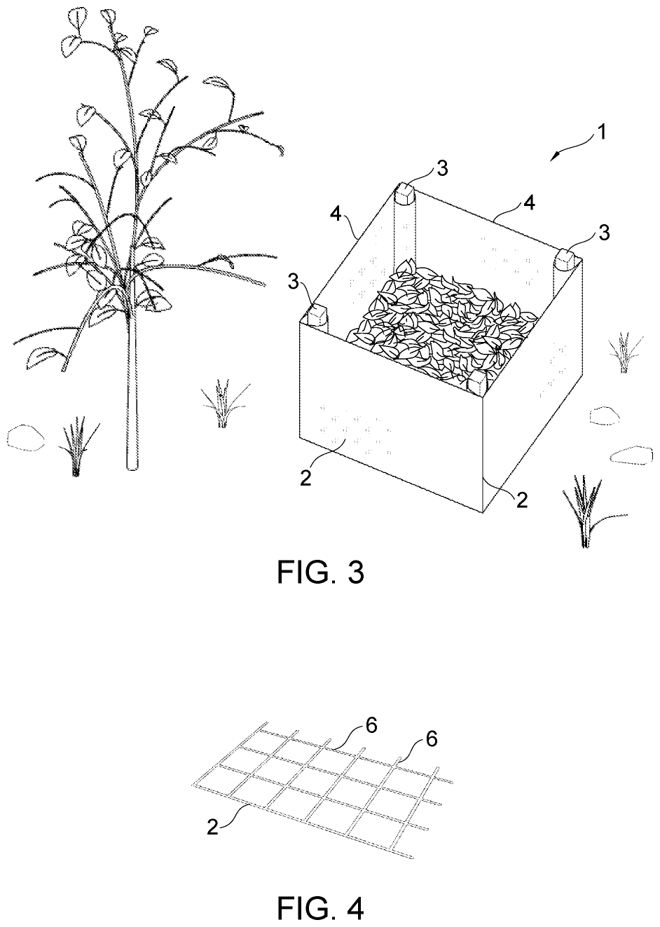

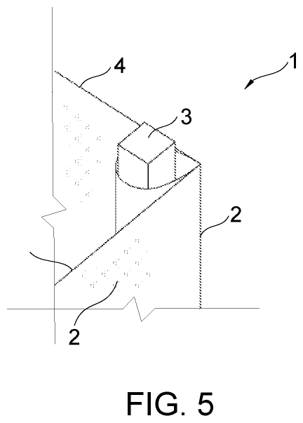

The compost bin 1 is capable of containing plant debris, including plant yard debris (for example grass clippings, leaves, bush clippings, an occasional twig and other compostable plant yard debris) and plant kitchen scraps (for example vegetable scraps, fruit scraps) (collectively or individually, “plant debris”) during a composting cycle. The time that compostable material is transformed into compost in a natural environment, under natural conditions, is referred to as a “composting cycle”. FIG. 3 shows a view of a compost bin 1 in a natural environment, the compost bin 1 containing plant debris. In embodiments of the present invention, the sheet 2 is made of material composition which is compostable in a natural environment, under naturally occurring conditions, including conditions of aeration (air), moisture (water), temperature (heat), the presence of microbial composting organisms, and other natural conditions. At the end of a composting cycle for the plant debris, not only has plant debris composted in the compost bin 1, but the sheet 2 itself has become very advanced in its composting cycle. The sheet 2 may be configured to be detachable from the members 3, and replaceable. After the compost bin 1 has received a pre-set quantity of plant debris, and the plant debris was transformed into compost, a user may detach the sheet 2, remove the compost, then attach a new sheet 2 to the same members 3, thereby constructing a new compost bin 1 which may be used in a new composting process. The detached sheet 2 may itself be placed in the new compost bin 1 to finalize its own composting process, which is already very advanced. The sheet 2 may be detachably attached to the members 3 for example by use of clips, thread, staples, seams which define sleeves for insertion of the members 3, or other attachment accessories. FIG. 5 is a non-limiting illustration of the sheet 2 detachably attached to members 3 by use of seams which define sleeves for insertion of the members 3.

The sheet 2 forms a chamber for example by connecting opposite edges of the sheet 2, such as by thread, seams or other connection accessories. FIG. 2 shows a side view of a compost bin 1, the sheet 2 forming a chamber having a first end 4, through which a user may load plant debris into the compost bin 1, and a second bottom end 5. The members 3 may be positioned at a pre-determined distance apart from each other and are each attached to the sheet 2, thereby keeping or supporting the first end 4 in an open configuration. The chamber also has a second bottom end 5 which may be open or closed and it may be placed against the ground to facilitate the entrance of lifeforms from the ground, which participate in the composting process.

In embodiments of the present invention, the compost bin members 3 may be an elongated supporting structure, for example poles, stakes, dowels, boards (hereinafter “poles”), which may be made of wood, but other materials may be used, for example metal, plastics or other natural or man-made materials. Poles made of wood are also compostable (though at a slower rate than plant debris) so that they too would not be thrown in the landfill or a recycling facility.

Composting rates of material composition depend on a number of factors, including the ratio of carbon: nitrogen of the material composition, the presence of composting microbial organisms, as well as the environmental conditions of aeration, moisture and temperature. A user may subject the plant debris to the composting process by ensuring the presence of natural conditions needed for composting, including air, water and heat, for example by adding water for moisture and turning the plant debris for aeration. The ratio of carbon to nitrogen (hereinafter, “C:N ratio”) is a ratio of the mass or weight of carbon to the mass or weight of nitrogen in a material composition. The C:N ratio relates to the rate of composting in an inverse manner, that is, higher C:N ratios correspond with slower rates of composting and lower C:N ratios correspond to faster rates of composting, when subject to the same environmental conditions.

The following are C:N ratios of various material composition, including average or typical C:N ratios.

The following are C:N ratios according to the USDA Natural Resources Conservation Service publication, ‘Carbon to Nitrogen Ratios in Cropping Systems’, published of January 2011:

| Material Composition | C:N Ratio |
|---|---|
| Legume hay | 17:1 |
| Ideal microbial diet | 24:1 |
| Pea straw | 29:1 |
| Oat straw | 70:1 |
| Wheat straw | 80:1 |
| Rye straw | 82:1 |

The following are C:N ratios according to reference tables to the USDA ‘Compost Calculation Worksheet’ dated March 2014, table 10-8 Typical carbon to nitrogen ratios of common composting amendments:

| Material Composition | C:N Ratio |
|---|---|
| Grass clippings | 19:1 |
| Garden wastes | 40:1 |
| Green leaves | 45:1 |
| Leaves (freshly fallen) | 60:1 |
| Straw | 60:1 |
| Paper | 173:1 |
| Cardboard | 300:1 |
| Newspaper | 450:1 |
| Saw dust | 512:1 |

The following are C:N ratios according to the USDA's publication ‘National Engineering Handbook’ published November 2010, Table 2A-1 Typical characteristics of selected raw materials:

| Material Composition | C:N Ratio |
|---|---|
| Vegetable wastes | 11:1-13:1 |
| Hay-legume | 16:1 |
| Grass clippings | 17:1 |
| Vegetable produce | 19:1 |
| Hay-nonlegume | 32:1 |
| Fruit wastes | 40:1 |
| Shrub trimmings | 53:1 |
| Leaves | 54:1 |
| Straw-oat | 60:1 |
| Straw-general | 80:1 |
| Wood-hardwoods (chips, shavings) | 560:1 |
| Wood-softwoods (chips, shavings) | 641:1 |

The following is a C:N ratio according to the publication ‘Decomposition of packing materials jute, Biopol, BAK and their composites in soil’, by K. Chander, A. K. Mohanty, and R. G. Joergensen, reference Biol Fertil Soils (2002) 36:344-349:

| Material Composition | C:N Ratio |
|---|---|
| Jute | 85:1 |

The following is a C:N ratio of coir (coconut fiber) according to the Ministry of Micro, Small and Medium enterprises government of India in publication ‘Coir Pith’ prepared for the India International Coir Fair of 2016:

| Material Composition | C:N Ratio |
|---|---|
| Coir | 112:1 |

In embodiments of the present invention, the C:N ratio of the sheet 2 is substantially consistent with the C:N ratio of plant debris. In embodiments of the present invention, the sheet 2 is compostable at a rate substantially consistent with the rate of composting of plant debris contained therein, in a natural environment under the same natural conditions. As an illustrative non-limiting example, an illustrative plant debris consisting of grass clippings, kitchen scraps for example vegetable waste, vegetable produce and fruit waste, garden waste, leaves including green leaves and freshly fallen leaves, based on the tables above, have C:N ratios including the C:N of grass clippings of 17:1 and 19:1, vegetable wastes and vegetable produce of 11:1-13:1 and 19:1, fruit waste of 40:1, garden waste of 40:1, leaves, green leaves and freshly fallen leaves of 40:1 or 54:1 or 60:1. The C:N ratio of this illustrative plant debris is 11:1 to 60:1. A sheet 2 made of straw, oat straw or straw-general, with a C:N ratio of 60:1, 70:1 or 80:1, or jute, with C:N of 85:1, has a C:N ratio which is equal to or higher than the C:N ratios of the plant debris, so that the composting rate of the sheet 2 is equal to or slower than the composting rate of the plant debris, and the composting cycle of sheet 2 would be equal to or longer than the composting cycle of the plant debris. In addition, the C:N ratio of the sheet 2 made of straw, oat straw or straw-general or jute, is sufficiently close to the C:N ratios of the plant debris, in this illustrative example the highest being the C:N ratio of leaves of 60:1, so that the composting rate of the sheet 2 is sufficiently close to the composting rate of the plant debris, and the composting cycle of the sheet 2 would be shorter than a multiplier of many composting cycles of the plant debris, resulting in the sheet 2 being very advanced in its composting cycle at the end of the plant debris composting cycle. There may also be an occasional twig in the plant debris, however an occasional twig or other wood plant debris does not affect the C:N ratios of the plant debris or its rates of composting, if the mass or weight of the twig or wood plant debris in the plant debris is negligible. The C:N ratio and rate of composting of the sheet 2 is considered by reference to the plant debris contained in the compost bin 1 which are non-negligible by mass or weight.

In embodiments of the present invention, the sheet 2 has a C:N ratio “substantially consistent” with the C:N ratio of the plant debris therein, that is, the sheet 2 has a C:N ratio which is equal to or higher than, but sufficiently close to, the C:N ratios of the plant debris, whereby the sheet 2 composting cycle is generally over a timeframe equal to or longer than the composting cycles of the plant debris contained therein, but shorter than a multiplier of many composting cycles of the plant debris contained therein. In embodiments of the present invention, the composting rate of sheet 2 is “substantially consistent” with the rate of composting of the plant debris, that is, the composting rate of sheet 2 is equal to or slower than, but sufficiently close to, the composting rate of plant debris, whereby the sheet 2 composting cycle is generally over a timeframe equal to or longer than the composting cycles of the plant debris contained therein, but shorter than a multiplier of many composting cycles of the plant debris contained therein.

The C:N ratio and rate of composting of plant debris varies in each bin, as a user may add more grass, or more leaves or other plant debris. The exact plant debris and exact C:N ratio and rate of composting of each plant debris in the compost bin 1 needs not be known; based on the tables above, the C:N ratio for plant debris may vary, however it is generally known for a pre-determined plant debris. As an illustrative example, the tables above provide C:N ratio for leaves of 40:1 or 45:1 or 60:1, and C:N ratio of straw of 60:1, 70:1 and 80:1, which may be due to natural variations including species of plants, or even different C:N ratio of the leafstalk versus the leaf blade. However, since it is known that the average or typical C:N ratio for leaves is generally between 45:1 to 60:1 based on these publications, and that the average or typical C:N ratio of straw is generally between 60: to 80:1, then a sheet 2 made of straw, oat straw or straw-general, with C:N ratio of 60:1 to 80:1, or jute, with C:N ratio of 85:1, has a C:N ratio substantially consistent with the C:N ratio of leaves with a C:N ratio of 45:1 to 60:1, and a rate of composting substantially consistent with the rate of composting of leaves.

The sheet 2 may be made of other substantially plant material composition. As a non-limiting example, the sheet 2 may be made of coir, with a C:N ratio of 112:1. A sheet 2 made of coir may be used when plant debris includes for example evergreen needles, which have a C: N ratio of 110:1. The sheet 2 has a C: N ratio substantially consistent with the C:N ratio of the plant debris and a rate of composting substantially consistent with the plant debris.

In the non-limiting illustrative examples above, the sheet 2 may be made of material composition for example straw—oat, straw—general, jute, or coir which have C:N ratios that are substantially consistent with the C:N ratios of the plant debris. These plant material compositions are exemplary, illustrative and non-limiting. The sheet may be made of other substantially plant material composition, for example flax, hemp, sisal, seagrass, cotton, linen, compostable textile or other substantially plant material composition. The material composition may be made from various parts of a plant, for example fiber, husk, bark, stalk, stem, pseudostem, sheath or other plant parts. The sheet 2 material composition may be natural untreated, or may have pre-determined treatments for example dyed, or other treatments. The sheet 2 material composition has sufficient strength to last for at least one composting cycle of the plant debris contained therein, under natural conditions.

The configuration of sheet 2 may be woven or unwoven or have woven or unwoven portions. FIG. 4 shows an enlarged partial view of a sheet 2 having a woven configuration. For example, woven or mesh configuration made of jute material composition includes burlap or hessian, which is a woven sheet which may weigh 5 to 12 oz. per square yard; or sacking, which is woven sheet made of coarser or lower quality jute and may weigh 12 to 20 oz. per square yard; or canvas, which is a finer woven sheet made of the best grades of jute. It is understood that sheets of many different grades made from plant material composition may be used as the material composition of sheet 2. The meshes 6 of the woven configuration may be sufficiently pervious to air, water and heat as necessary for the composting process. The meshes 6 may also be woven sufficiently tight so that they substantially retain the plant debris. The sheet 2 may have a non-woven configuration, for example, felt made of plant material composition, or non-woven compostable textile made of plant material composition. The non-woven configuration may also be pervious to air, water and heat, for example it may be needle-punched or have holes.

The Federal Trade Commission (“FTC”) has published in the Federal Register 16 CFR part 260 ‘Guides for use of environmental marketing claims’, specifically 260.7, which is a guide for the use of the “compostable” “marketing claims” (as described in the Federal register, hereinafter referred to as compostable “attributes”, so as not to be confused with the claims of the present invention). These guidelines guide companies in describing to users the environmental attributes of items. According to the FTC guidelines, the “compostable” attribute may be applied in describing an item if “all the materials in the item will break down into, or otherwise become part of, usable compost (e.g., soil-conditioning material, mulch) in a safe and timely manner (i.e., in approximately the same time as the materials with which it is composted) in an appropriate composting facility, or in a home compost pile or device.” According to the FTC guidelines, “compostable” attributes may be “unqualified” or “qualified”. The “compostable” attribute must be “qualified” when “the item cannot be composted safely or in a timely manner in a home compost pile or device”. An example provided in the FTC guidelines further indicates that an item which is compostable in municipal or institutional composting facilities, but not in a home environment, that is, a natural environment, should be “qualified”: “Example 3: A manufacturer makes an unqualified claim that its package is compostable. Although municipal or institutional composting facilities exist where the product is sold, the package will not break down into usable compost in a home compost pile or device . . . the manufacturer should clearly and prominently disclose that the package is not suitable for home composting.”

In embodiments of this invention, the sheet 2 may be made of material composition which meets the “unqualified” “compostable” attribute according to the FTC guidelines, as the sheet 2 transforms into compost in a safe and timely manner in a natural environment, for example a home compost pile or device. Examples are sheet 2 made of natural untreated plant material composition for example burlap made of natural untreated jute or other woven or unwoven natural untreated plant material composition.

In embodiments of this invention, the sheet 2 may be made of plant material composition treated with dyes or other treatments, whereby the treatment does not alter the resulting compost in a way which makes it unusable as compost, and the sheet 2 is still compostable in a safe and timely manner in a natural environment, for example a home compost pile or device. However, if the treatment diminishes some of the soil-conditioning or soil-amendment benefits of the compost, the material composition may meet the “qualified” “compostable” attribute according to the FTC guidelines.

The compost bin 1 may have any size, for example a volume size of 10 cubic feet to 36 cubic feet, (for example 2 feet wide×2 feet long×2.5 feet high to 3 feet wide×3 feet long×4 feet high), and may have other smaller or larger sizes. The compost bin 1 may have any shape. An example is a compost bin 1 shape formed by 4 members positioned in a square or rectangular horizontal sectional shape, but the compost bin 1 may have another number of members positioned in another shape. The compost bin 1 may be placed in any suitable location where natural conditions for composting exist, for example a yard, garden, a wooded area.

Embodiments of the present invention are an ecological compost bin 1 which is beneficial to the environment, not only by containing plant debris during the composting process, but also having a sheet 2 which is compostable into useful compost under natural conditions, the sheet 2 having a C:N ratio substantially consistent with the C:N ratio of the plant debris contained therein, and a rate of composting substantially consistent with the rate of composting of the plant debris contained therein.

The objectives and advantages of the present invention will be realized or attained by means of the elements and combinations particularly pointed out in the claims. It is to be understood that the foregoing summary of the invention, drawings and description of the invention are exemplary and explanatory and are not restrictive or limiting of the present invention.

1. A device for composting plant debris, the device comprising:
at least one sheet forming a chamber for containment of plant debris, the chamber having a first end for receiving plant debris and a second bottom end
a plurality of members, wherein said sheet is configured to be detachably attached to said members
said members being configured to support the first end of the chamber formed by said sheet, in an open configuration
said sheet being made of material composition which is compostable in a natural environment
said sheet being compostable at a rate substantially consistent with the rate of composting of plant debris contained therein.

2. The device of claim 1, wherein said sheet is made of material composition which is substantially plant material composition.

3. The device of claim 1, wherein said sheet is made of material composition which is substantially at least one of: jute, straw, coir, hemp, flax, sisal, seagrass, linen, cotton, compostable textile or combinations thereof.

4. The device of claim 1, wherein at least a portion of said sheet has a substantially woven configuration.

5. The device of claim 4, wherein said woven configuration is sufficiently pervious to air, water and heat, for composting.

6. The device of claim 1, wherein at least a portion of said sheet has a substantially non-woven configuration.

7. The device of claim 1, wherein said members comprise poles.

8. A device for composting plant debris, the device comprising:
at least one sheet forming a chamber for containment of plant debris, the chamber having a first end for receiving plant debris, and a second bottom end
a plurality of members, wherein said sheet is configured to be detachably attached to said members
said members being configured to support the first end of the chamber formed by said sheet, in an open configuration
said sheet being made of material composition which is compostable in a natural environment
said sheet having a carbon:nitrogen ratio substantially consistent with the carbon:nitrogen ratio of plant debris contained therein.

9. The device of claim 8, wherein said sheet has a carbon:nitrogen ratio of up to 112:1.

10. The device of claim 8, wherein said sheet is made of material composition which is substantially plant material composition.

11. The device of claim 8, wherein said sheet is made of material composition which is substantially at least one of: jute, straw, coir, hemp, flax, sisal, seagrass, linen, cotton, compostable textile or combinations thereof.

12. The device of claim 8, wherein at least a portion of said sheet has a substantially woven configuration.

13. The device of claim 12, wherein said woven configuration is sufficiently pervious to air, water and heat, for composting.

14. The device of claim 8, wherein at least a portion of said sheet has a substantially non-woven configuration.

15. The device of claim 8, wherein said members comprise poles.
